(19) United States
(12) Patent Application Publication
(10) Pub. No.: US 2017/0353074 A1
(43) Pub. Date: Dec. 7, 2017

(54) ROTOR FOR ROTATING ELECTRIC MACHINE

(71) Applicant: DENSO CORPORATION, Kariya-city (JP)

(72) Inventors: Yuuki TAKAHASHI, Kariya-city (JP); Atsushi UMEDA, Kariya-city (JP)

(73) Assignee: DENSO CORPORATION, Kariya-city (JP)

(21) Appl. No.: 15/612,558

(22) Filed: Jun. 2, 2017

(30) Foreign Application Priority Data
Jun. 3, 2016 (JP) 2016-112283

(51) Int. Cl. H02K 3/32; H02K 1/08

(52) U.S. Cl. CPC H02K 3/325; H02K 1/08

(57) ABSTRACT

A rotor for a rotating electric machine includes a field core having a plurality of claw-shaped magnetic pole portions, a field coil wound on the field core, and a hollow cylindrical core member disposed to cover radially outer peripheries of the claw-shaped magnetic pole portions of the field core. The core member has a plurality of first electrically-insulating portions that are spaced at first intervals in an axial direction of the core member. Each of the claw-shaped magnetic pole portions of the field core has a radially outer peripheral surface abutting the core member and a plurality of second electrically-insulating portions provided on the radially outer peripheral surface. The second electrically-insulating portions are spaced at second intervals in the axial direction of the core member.

### CROSS-REFERENCE TO RELATED APPLICATION

This application is based on and claims priority from Japanese Patent Application No. 2016-112283, filed on Jun. 3, 2016, the content of which is hereby incorporated by reference in its entirety into this application.

### BACKGROUND

### 1 Technical Field

The present invention relates to rotors for rotating electric machines that are used in, for example, motor vehicles as electric motors and electric generators.

### 2 Description of Related Art

There are known rotating electric machines that are used in, for example, motor vehicles as electric motors and electric generators. These rotating electric machines include a stator having a stator coil wound on a stator core and a rotor that is rotatably disposed so as to radially face the stator through a predetermined air gap formed therebetween.

Moreover, there are also known Lundell-type rotors which include a field core and a field coil. The field core has a cylindrical boss portion fixed on a rotating shaft and a plurality of claw-shaped magnetic pole portions located radially outward of the boss portion. The field coil is wound on a radially outer periphery of the boss portion of the field core. In operation, upon energization of the file coil, the claw-shaped magnetic pole portions of the field core are magnetized to respectively form a plurality of magnetic poles whose polarities alternate between north and south in a circumferential direction of the rotating shaft.

Japanese Patent Application Publication No. JP2009148057A discloses a hollow cylindrical (or annular) core member employed in a Lundell-type rotor. The core member is disposed to cover (or surround) radially outer peripheries of the claw-shaped magnetic pole portions of the field core. Consequently, with the core member, it is possible to reduce fluctuation in magnetic flux transferred between the rotor and the stator during rotation of the rotor. As a result, it is possible to reduce magnetic noise caused by the fluctuation in the magnetic flux. Moreover, since the claw-shaped magnetic pole portions of the field core are connected with each other by the core member, it is possible to suppress the radially outward deformation of the claw-shaped magnetic pole portions due to the centrifugal force during rotation of the rotor.

Furthermore, the core member disclosed in the above patent document is formed of a laminate obtained by laminating a plurality of soft-magnetic sheets in an axial direction of the core member. Consequently, it is possible to reduce eddy current loss in the core member.

However, the inventors of the present application have found that the core member disclosed in the above patent document involves the following problem.

In terms of preventing occurrence of a magnetic short circuit in the core member and improving the magnetic performance of the core member, it is preferable to set the radial thickness of the core member as small as possible. On the other hand, the smaller the radial thickness of the core comber, the less the achievable reduction in the eddy current loss in the core member. Therefore, if the radial thickness of the core comber is too small, it may be difficult to sufficiently reduce the total eddy current loss in the rotor.

### SUMMARY

According to an exemplary embodiment, there is provided a rotor for a rotating electric machine. The rotor includes a field core having a plurality of claw-shaped magnetic pole portions, a field coil wound on the field core, and a hollow cylindrical core member disposed to cover radially outer peripheries of the claw-shaped magnetic pole portions of the field core. The core member has a plurality of first electrically-insulating portions that are spaced at first intervals in an axial direction of the core member. Each of the claw-shaped magnetic pole portions of the field core has a radially outer peripheral surface abutting the core member and a plurality of second electrically-insulating portions provided on the radially outer peripheral surface. The second electrically-insulating portions are spaced at second intervals in the axial direction of the core member.

With the above configuration, eddy current generated in the core member is fragmented (or divided) by the first electrically-insulating portions of the core member; thus the eddy current loss in the core member can be reduced. Moreover, for each of the claw-shaped magnetic pole portions of the field core, eddy current generated in the claw-shaped magnetic pole portion is fragmented by the second electrically-insulating portions provided on the radially outer peripheral surface of the claw-shaped magnetic pole portion; thus the eddy current loss in the claw-shaped magnetic pole portion can be reduced. Hence, it is unnecessary to increase the radial thickness of the core member for the purpose of reducing the total eddy current loss in the rotor. Consequently, it becomes possible to effectively reduce the total eddy current loss in the rotor with the radial thickness of the core member kept small.

It is preferable that the first intervals are unequal to the second intervals.

The core member may be formed of a plurality of soft-magnetic bodies that are laminated in the axial direction of the core member. The first electrically-insulating portions may include a plurality of insulating layers each of which is interposed between one axially-adjacent pair of the soft-magnetic bodies to electrically insulate the pair of the soft-magnetic bodies from each other.

The second electrically-insulating portions may include a plurality of grooves formed in the radially outer peripheral surface of the claw-shaped magnetic pole portion.

In a further implementation, the claw-shaped magnetic pole portions of the field core are spaced in a circumferential direction of the core member with gaps formed therebetween. The field coil is wound on the field core so that upon energization of the field coil, the claw-shaped magnetic pole portions are magnetized to respectively form a plurality of magnetic poles whose polarities alternate between north and south in the circumferential direction. The rotor is rotatably disposed radially inside a stator in a rotating electric machine. The core member is preferably formed so that an air gap between the core member and the stator is greater at portions of the core member which respectively face the gaps between the claw-shaped magnetic pole portions than at portions of the core member which respectively abut the claw-shaped magnetic pole portions.

It is preferable that the core member has a lower magnetic permeability than the field core.

It is also preferable that the core member has a higher saturation flux density than the field core.

The field core may consist of a pair of first and second pole cores. Each of the first and second pole cores has a boss portion, a disc portion and a plurality of claw-shaped magnetic pole portions. The boss portion is cylindrical in shape. The disc portion extends radially outward from an axially outer part of the boss portion. Each of the claw-shaped magnetic pole portions protrudes axially inward from a radially outer part of the disc portion. The claw-shaped magnetic pole portions of the first and second pole cores constitute the claw-shaped magnetic pole portions of the field core. The claw-shaped magnetic pole portions of the first pole core are interleaved with the claw-shaped magnetic pole portions of the second pole core. The field coil is wound on radially outer peripheries of the boss portions of the first and second pole cores so that upon energization of the field coil, the claw-shaped magnetic pole portions of the first and second pole cores are magnetized to respectively form a plurality of magnetic poles whose polarities alternate between north and south in the circumferential direction of the core member.

### BRIEF DESCRIPTION OF THE DRAWINGS

The present invention will be understood more fully from the detailed description given hereinafter and from the accompanying drawings of one exemplary embodiment, which, however, should not be taken to limit the present invention to the specific embodiment but are for the purpose of explanation and understanding only.

In the accompanying drawings:

FIG. 1 is a schematic cross-sectional view, along an axial direction, of a rotating electric machine which includes a rotor according to an exemplary embodiment;

FIG. 2 is a perspective view of the rotor according to the embodiment;

FIG. 3 is a perspective view of the rotor according to the embodiment omitting a hollow cylindrical core member of the rotor;

FIG. 4 is a side view, from the radially outside, of the rotor according to the embodiment;

FIG. 5 is a perspective view of the rotor according to the embodiment omitting the core member and illustrating the shape of radially outer peripheral surfaces of claw-shaped magnetic pole portions of a field core of the rotor;

FIG. 6 is a partially cross-sectional view of part of the rotor according to the embodiment;

FIG. 7 is a schematic view illustrating eddy current loops generated in the rotor according to the embodiment;

FIG. 8 is a side view, from the radially outside, of a rotor according to a modification; and

FIG. 9 is a cross-sectional view of part of the rotor according to the modification taken along the line IX-IX in FIG. 8.

### DESCRIPTION OF EMBODIMENT

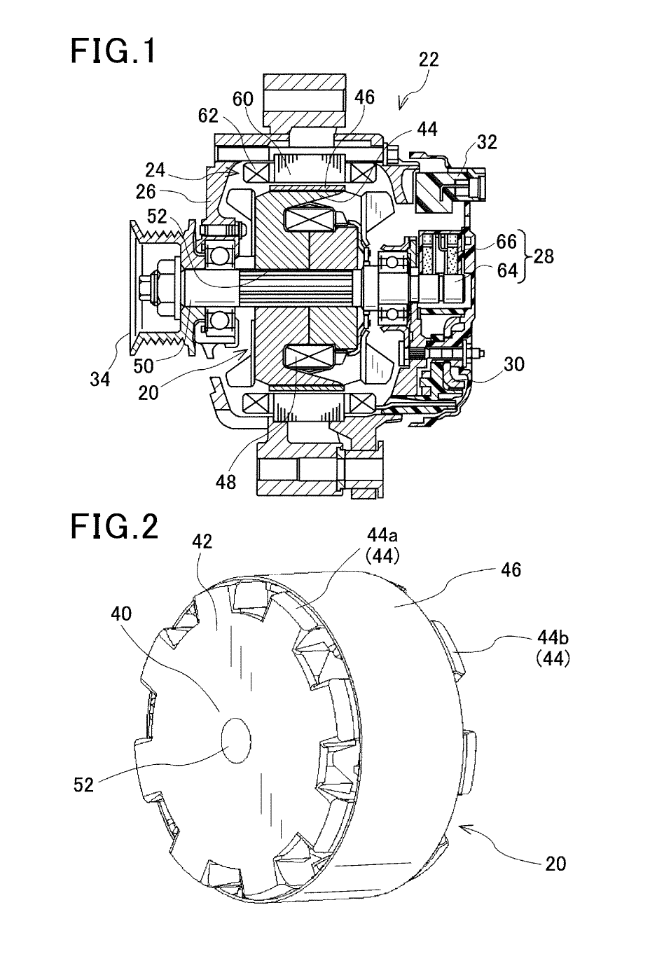

FIG. 1 shows the overall configuration of a rotating electric machine 22 which includes a rotor 20 according to an exemplary embodiment.

In the present embodiment, the rotating electric machine 22 is configured as a motor-generator for use in a motor vehicle. Specifically, upon being supplied with electric power from a battery (not shown) of the vehicle, the rotating electric machine 22 functions as an electric motor to generate torque (or driving force) for driving the vehicle. Otherwise, upon being supplied with torque from an engine (not shown) of the vehicle, the rotating electric machine 22 functions as an electric generator to generate electric power for charging the battery.

As shown in FIG. 1, the rotating electric machine 22 includes the rotor 20, a stator 24, a housing 26, a brush device 28, a rectifier 30, a voltage regulator 32 and a pulley 34.

As shown in FIGS. 1-3, the rotor 20 includes a field core, a hollow cylindrical (or annular) core member 46, a field coil 48 and a plurality of permanent magnets 49.

The field core consists of first and second pole cores that are made of a soft-magnetic material. Each of the first and second pole cores includes a boss portion 40, a disc portion 42 and a plurality of claw-shaped magnetic pole portions 44.

The boss portion 40 is cylindrical in shape and has a shaft hole 52 formed along its central axis. In the shaft hole 52, there is fixedly fitted a rotating shaft 50 (see FIG. 1). In other words, the boss portion 40 is fixedly fitted on an outer periphery of the rotating shaft 50.

The disc portion 42 is disc-shaped and extends radially outer ward from an axially outer part of the boss portion 40.

Each of the claw-shaped magnetic pole portions 44 protrudes axially inward in the shape of a claw from a radially outer part of the disc portion 42. That is, each of the claw-shaped magnetic pole portions 44 is located radially outward of the boss portion 40. Moreover, each of the claw-shaped magnetic pole portions 44 has a radially outer peripheral surface that is shaped in a circular arc having its center located in the vicinity of a central axis O of the rotating shaft 50 (more specifically, located on the central axis O of the rotating shaft 50 or slightly offset toward the claw-shaped magnetic pole portion 44 from the central axis O).

Hereinafter, for the sake of ease of explanation, the claw-shaped magnetic pole portions 44 of the first pole core will be referred to as first claw-shaped magnetic pole portions 44a while the claw-shaped magnetic pole portions 44 of the second pole core will be referred to as second claw-shaped magnetic pole portions 44b.

The first claw-shaped magnetic pole portions 44a have the same shape as the second claw-shaped magnetic pole portions 44b. Moreover, the number of the first claw-shaped magnetic pole portions 44a is equal to the number of the second claw-shaped magnetic pole portions 44b. More particularly, in the present embodiment, both the number of the first claw-shaped magnetic pole portions 44a and the number of the second claw-shaped magnetic pole portions 44b are set to 8. Consequently, the total number of the claw-shaped magnetic pole portions 44 of the field core is equal to 16 (i.e., 8 north poles and 8 south poles).

The first and second pole cores are assembled together so that the first claw-shaped magnetic pole portions 44a are interleaved with the second claw-shaped magnetic pole portions 44b. Consequently, the first claw-shaped magnetic pole portions 44a are arranged alternately with the second claw-shaped magnetic pole portions 44b in a circumferential direction of the rotor 20. Moreover, between each circumferentially-adjacent pair of the first and second claw-shaped magnetic pole portions 44a and 44b, there is formed a gap 54.

In addition, it should be noted that the boss portions 40 of the first and second pole cores, which abut each other in an axial direction of the rotor 20, may be integrally formed to make up a common boss portion to the first and second pole cores.

Each of the claw-shaped magnetic pole portions 44 of the field core (i.e., the first and second claw-shaped magnetic pole portions 44a and 44b) has both a predetermined width in the circumferential direction of the rotor 20 and a predetermined thickness in a radial direction of the rotor 20. Moreover, for each of the claw-shaped magnetic pole portions 44, both the circumferential width and the radial thickness of the claw-shaped magnetic pole portion 44 are gradually decreased from a proximal end part (or root part) to a distal end part of the claw-shaped magnetic pole portion 44. That is, each of the claw-shaped magnetic pole portions 44 is gradually decreased in size in both the circumferential and radial directions of the rotor 20 from the proximal end part to the distal end part thereof.

All the gaps 54 formed between circumferentially-adjacent first and second claw-shaped magnetic pole 44a and 44b have the same shape. Moreover, each of the gaps 54 has a substantially constant circumferential width in the axial direction of the rotor 20.

In addition, in terms of preventing occurrence of magnetic unbalance in the rotor 20, it is preferable for all the gaps 54 to have the same shape. However, in the case where the rotor 20 is designed to rotate only in one direction, to reduce the iron loss in the rotor 20, the claw-shaped magnetic pole portions 44 may be modified to have an asymmetrical shape with respect to a reference line that radially extends through the central axis 0 of the rotating shaft 50, thereby making the circumferential width of each of the claw-shaped magnetic pole portions 44 vary in the axial direction of the rotor 20.

The core member 46 has a hollow cylindrical (or annular) shape and is disposed radially outside the claw-shaped magnetic pole portions 44 of the field core (or the first and second claw-shaped magnetic pole portions 44a and 44b of the first and second pole cores) so as to cover (or surround) the radially outer peripheries of the claw-shaped magnetic pole portions 44. The core member 46 has a radial thickness that is set to be in the range of, for example, 0.6 mm-1.0 m so as to ensure both the mechanical strength and the magnetic performance of the core member 46 in the rotor 20. Moreover, the core member 46 is provided in contact with the radially outer peripheral surfaces of the claw-shaped magnetic pole portions 44. Consequently, each circumferentially-adjacent pair of the claw-shaped magnetic pole portions 44 are connected with each other by the core member 46 with the gap 54 formed therebetween covered by the core member 46 from the radially outside.

The core member 46 is made of a soft-magnetic material such as magnetic steel. As shown in FIG. 4, the core member 46 is formed by laminating a plurality of soft-magnetic sheets (e.g., magnetic steel sheets) 56 in an axial direction thereof. Each of the soft-magnetic sheets 56 has both a predetermined thickness in a radial direction of the core member 46 and a predetermined width in the lamination direction (or the axial direction of the core member 46).

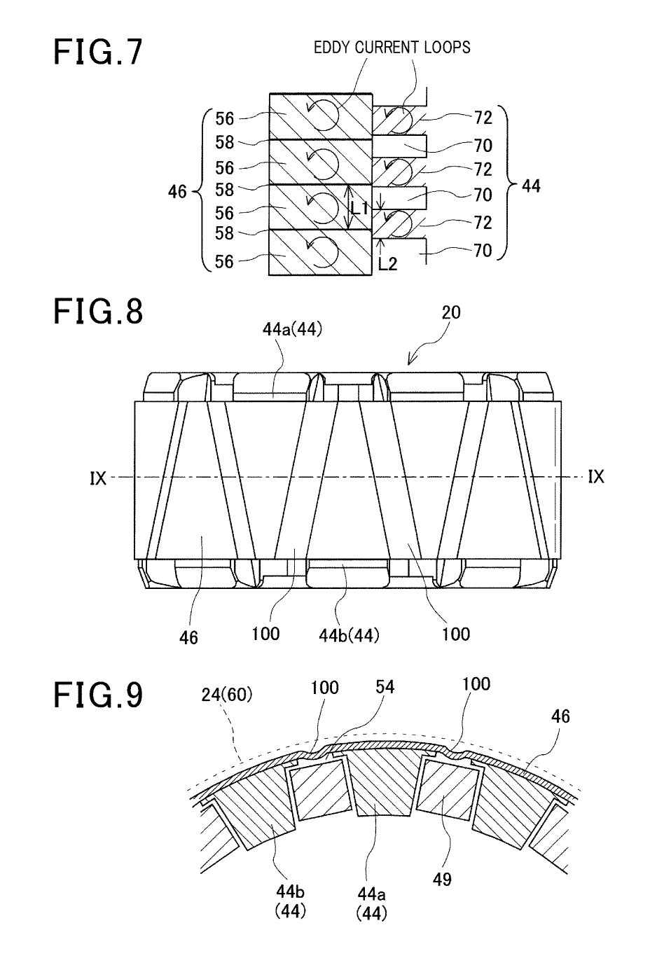

Moreover, as shown in FIG. 7, for suppressing eddy current loss in the core member 46, between each axially-adjacent pair of the soft-magnetic sheets 56, there is interposed an insulating layer 58 to electrically insulate the pair of the soft-magnetic sheets 56 from each other.

In addition, the core member 46 is fixed to the claw-shaped magnetic pole portions 44 of the field core by one or a combination of shrinkage fitting, press fitting and welding.

Referring back to FIG. 1, the field coil 48 is wound on both the radially outer peripheries of the boss portions 40 of the first and second pole cores. Consequently, the field coil 48 is surrounded by the boss portions 40, the disc portions 42 and the claw-shaped magnetic pole portions 44 of the first and second pole cores.

The field coil 48 generates magnetic flux upon being supplied with DC field current. The generated magnetic flux then flows to the claw-shaped magnetic pole portions 44 via the boss portions 40 and the disc portions 42 of the first and second pole cores. Consequently, the claw-shaped magnetic pole portions 44 are magnetized to respectively form a plurality (e.g., 16 in the present embodiment) of magnetic poles whose polarities alternate between north and south in the circumferential direction of the rotor 20. For example, each of the first claw-shaped magnetic pole portions 44a is magnetized to form a north pole while each of the second claw-shaped magnetic pole portions 44b is magnetized to form a south pole.

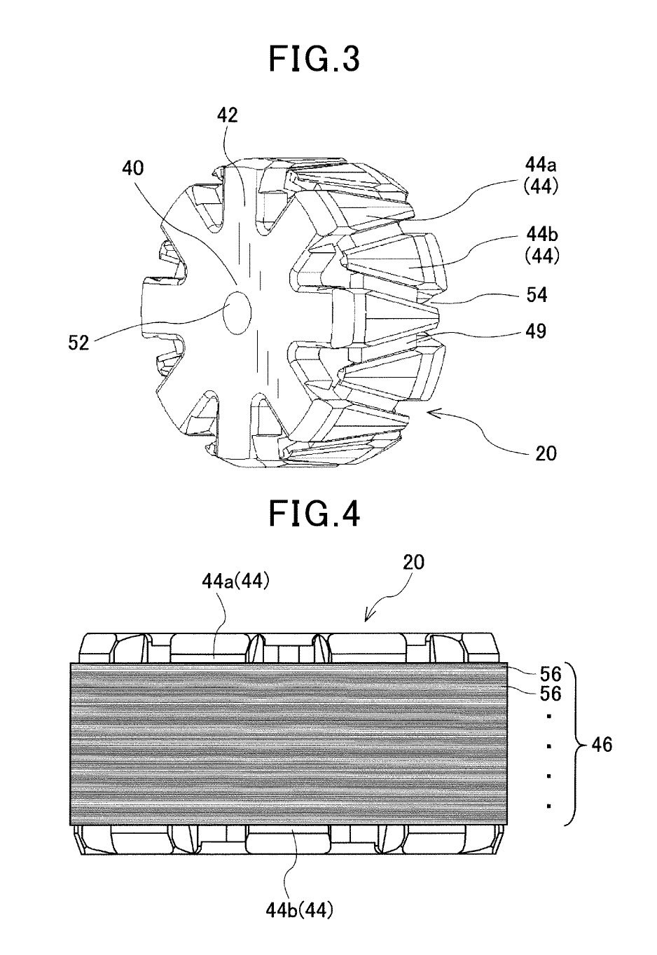

As shown in FIG. 3, each of the permanent magnets 49 is arranged in one of the gaps 54 formed between circumferentially-adjacent first and second claw-shaped magnetic pole portions 44a and 44b. That is, each of the permanent magnets 49 is provided as an inter-pole magnet which is arranged radially inside the core member 46 and between one circumferentially-adjacent pair of the first and second claw-shaped magnetic pole portions 44a and 44b. Moreover, the permanent magnets 49 are held by a magnet holder (not shown) so that the centrifugal force acting on the permanent magnets 49 during rotation of the rotor 20 is transmitted to the first and second claw-shaped magnetic pole portions 44a and 44b via the magnet holder.

Each of the permanent magnets 49, which is arranged between one circumferentially-adjacent pair of the first and second claw-shaped magnetic pole portions 44a and 44b, is magnetized so as to reduce magnetic flux leakage between the circumferentially-adjacent pair of the first and second claw-shaped magnetic pole portions 44a and 44b, thereby strengthening magnetic flux transferred between the rotor 20 and the stator 24. Specifically, each of the permanent magnets 49 is magnetized so that: the north pole of the permanent magnet 49 faces one of the circumferentially-adjacent pair of the first and second claw-shaped magnetic pole portions 44a and 44b which is magnetized to form a north pole upon energization of the field coil 48; and the south pole of the permanent magnet 49 faces the other of the circumferentially-adjacent pair of the first and second claw-shaped magnetic pole portions 44a and 44b which is magnetized to form a south pole upon energization of the field coil 48. That is, each of the permanent magnets 49 is magnetized so as to generate a magnetomotive force in the circumferential direction of the rotor 20. In addition, the permanent magnets 49 may be magnetized either before or after being assembled into the rotor 20.

Referring again to FIG. 1, the stator 24 includes a hollow cylindrical (or annular) stator core 60 and a three-phase stator coil (or armature coil) 62. The stator core 60 is disposed radially outside the rotor 20 so as to radially face the rotor 20 through a predetermined air gap formed therebetween. The stator core 60 has a plurality of teeth (not shown) and a plurality of slots (not shown) formed therein. The teeth each radially extend and are circumferentially spaced at a predetermined pitch. Each of the slots is formed between one circumferentially-adjacent pair of the teeth. The stator coil 62 is comprised of three phase windings (e.g., U-phase, V-phase and W-phase windings) that are wound on the stator core 60 so as to be received in the slots of the stator core 60.

In addition, in the present embodiment, the stator 24 functions as an armature while the rotor 20 functions as a field.

The housing 26 receives both the rotor 20 and the stator 24 therein. The housing 26 supports, via a pair of bearings, the rotating shaft 50 so that the rotating shaft 50 can rotate together with the rotor 20. Moreover, the housing 26 has the stator 24 fixed therein.

The brush device 28 includes a pair of slip rings 64 and a pair of brushes 66. The slip rings 64 are provided on a rear end portion (i.e., a right end portion in FIG. 1) of the rotating shaft 50 and respectively electrically connected with opposite ends of the field coil 48. The brushes 66 are held by a brush holder that is fixed to the housing 26. Moreover, the brushes 66 are respectively spring-loaded on the slip rings 64 to establish sliding contacts with them during rotation of the rotor 20.

The rectifier 30 is electrically connected with the three-phase stator coil 62 of the stator 24. The rectifier 30 is configured to rectify three-phase AC power outputted from the stator coil 62 into DC power.

The voltage regulator 32 is configured to regulate an output voltage of the rotating electric machine 22 by controlling the field current supplied to the field coil 48. Consequently, with the voltage regulator 32, it is possible to keep the output voltage of the rotating electric machine 22 substantially constant which otherwise varies according to electrical loads fed by the rotating electric machine 22 and the amount of electric power generated by the rotating electric machine 22.

The pulley 34 is fixed on a front end portion (i.e., a left end portion in FIG. 1) of the rotating shaft 50, so that torque generated by the engine of the vehicle can be transmitted to the rotor 20 via the pulley 34, thereby driving the rotor 20 to rotate.

As mentioned previously, in the present embodiment, the rotating electric machine 22 is configured as a motor-generator that selectively operates in either a motor mode or a generator mode.

In the motor mode, the DC field current is supplied from the battery of the vehicle to the field coil 48 via the brush device 28. With the supply of the field current to the field coil 48, the claw-shaped magnetic pole portions 44 of the field core are magnetized to respectively form the magnetic poles whose polarities alternate between north and south in the circumferential direction of the rotor 20. Then, DC power supplied from the battery is converted into three-phase AC power by an inverter (not shown) and the obtained three-phase AC power is supplied to the stator coil 62, thereby causing the rotor 20 to rotate in a predetermined direction and generate torque.

In the generator mode, upon transmission of torque from the engine of the vehicle to the rotating shaft 50 via the pulley 34, the rotor 20 rotates in a predetermined direction. During rotation of the rotor 20, the DC field current is supplied from the battery of the vehicle to the field coil 48 via the brush device 28. With the supply of the field current to the field coil 48, the claw-shaped magnetic pole portions 44 of the field core are magnetized to respectively form the magnetic poles whose polarities alternate between north and south in the circumferential direction of the rotor 20. Consequently, a rotating magnetic field is created which causes the three-phase AC power to be generated in the stator coil 62. The three-phase AC power is then rectified by the rectifier 30 into the DC power. The DC power is used to, for example, charge the battery. In addition, the output voltage of the rotating electric machine 22 (or the voltage of the DC power) is regulated by the voltage regulator 32.

Next, the characteristic configuration of the rotor 20 according to the present embodiment will be described in detail with reference to FIGS. 4-7.

In the present embodiment, the rotor 20 includes the hollow cylindrical core member 46 that is disposed to cover (or surround) the radially outer peripheries of the claw-shaped magnetic pole portions 44 of the field core. Consequently, with the core member 46, it becomes possible to make the radially outer periphery of the entire rotor 20 smooth, thereby reducing wind noise caused by unevenness of the radially outer periphery of the rotor 20.

Moreover, in the present embodiment, the claw-shaped magnetic pole portions 44 of the field core are connected with each other by the core member 46. Consequently, it becomes possible to suppress the radially outward deformation of the claw-shaped magnetic pole portions 44 due to the centrifugal force during rotation of the rotor 20. In particular, in the present embodiment, the rotor 20 includes the permanent magnets 49 each of which is arranged in one of the gaps 54 formed between circumferentially-adjacent claw-shaped magnetic pole portions 44. During rotation of the rotor 20, the centrifugal force acting on the permanent magnets 49 is transmitted to the claw-shaped magnetic pole portions 44; thus the amount of radially outward deformation of the claw-shaped magnetic pole portions 44 may be increased. However, with the core member 46, it is still possible to suppress increase in the amount of radially outward deformation of the claw-shaped magnetic pole portions 44 even though the centrifugal force acting on the permanent magnets 49 is transmitted to the claw-shaped magnetic pole portions 44.

Moreover, in the present embodiment, the core member 46 is formed of the soft-magnetic sheets 56 that are laminated in the axial direction of the core member 46. Between each axially-adjacent pair of the soft-magnetic sheets 56, there is interposed one of the insulating layers 58 to electrically insulate the pair of the soft-magnetic sheets 56 from each other. As shown in FIG. 7, the insulating layers 58 are spaced at first intervals L1 in the axial direction of the core member 46 (or the lamination direction of the soft-magnetic sheets 56). The size of the first intervals L1 is equal to the predetermined width of each of the soft-magnetic sheets 56 in the axial direction of the core member 46.

In addition, the insulating layers 58 may be formed of an insulating material (e.g., oxide films) provided on the axial end surfaces of the soft-magnetic sheets 56 by painting or coating. Alternatively, the insulating layers 58 may be formed of minute air gaps provided between axially-adjacent soft-magnetic sheets 56.

With the insulating layers 58, it becomes possible to reduce eddy current loss in the core member 46, thereby improving the efficiency of the rotating electric machine 22.

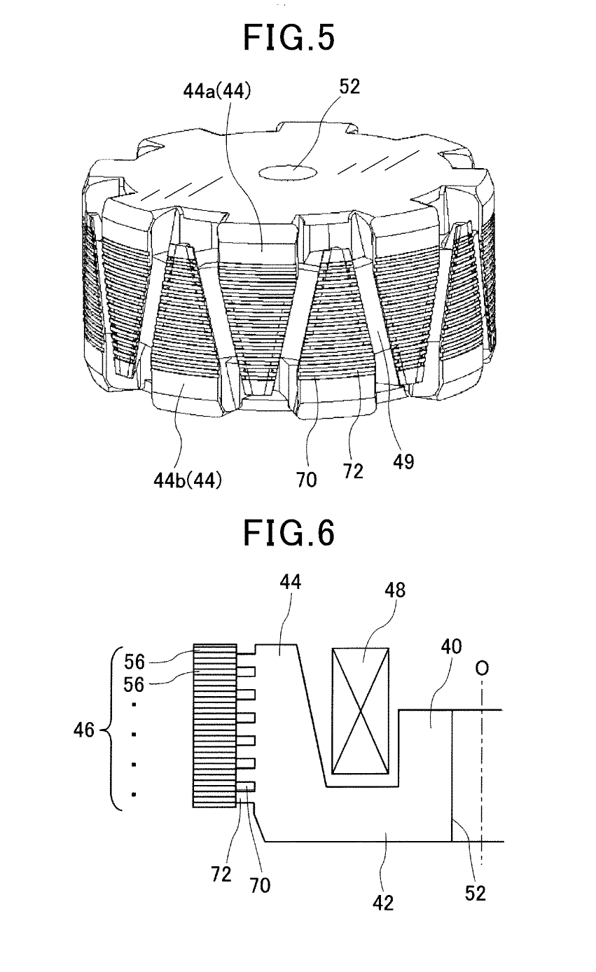

Moreover, in the present embodiment, as shown in FIGS. 5-6, each of the claw-shaped magnetic pole portions 44 of the field core has a plurality of grooves (or recesses) 70 formed in the radially outer peripheral surface thereof; the radially outer peripheral surface abuts a radially inner peripheral surface of the core member 46. As shown in FIG. 7, the grooves 70 are spaced at second intervals L2 in the axial direction of the core member 46. Between each axially-adjacent pair of the grooves 70, there is formed one abutting portion (or protrusion) 72 of the claw-shaped magnetic pole portion 44 which abuts (or makes contact with) the radially inner peripheral surface of the core member 46. In other words, each of the grooves 70 is formed between one axially-adjacent pair of the abutting portions 72 of the claw-shaped magnetic pole portion 44 and constitutes an insulating layer (or air layer) that electrically insulates the pair of the abutting portions 72 from each other. The depth of the grooves 70 is set such that an eddy current loop can be formed in each of the abutting portions 72 without impairing the magnetic performance of the claw-shaped magnetic pole portion 44.

The grooves 70 may be formed, at intervals of 0.1 mm-2 mm, by grooving using a special grooving machine. Alternatively, the grooves 70 may be formed by knurling without using a special grooving machine. Moreover, the grooves 70 may be formed of cutting traces or tool marks which remain on the radially outer peripheral surface of the claw-shaped magnetic pole portion 44 after machining the claw-shaped magnetic pole portion 44. Alternatively, the grooves 70 may be formed of adhesive pools where an adhesive is pooled; the adhesive is used in covering the radially outer peripheries of the claw-shaped magnetic pole portions 44 with the core member 46.

In the present embodiment, the second intervals L2 are set to be unequal to the first intervals L1. Moreover, the second intervals L2 may be set to a constant value; in this case, the grooves 70 are arranged in the axial direction of the core member 46 at a constant pitch. Alternatively, the second intervals L2 may be set to a plurality of different values which may include a value equal to the first intervals L1; in this case, the grooves 70 are arranged in the axial direction of the core member 46 at unequal pitches. For example, the second intervals L2 may be set to 5 μm or 10 μm. In addition, though the second intervals L2 are shown as being less than the first intervals L1 in FIG. 7, the second intervals L2 may also be set to be greater than the first intervals L1.

As described above, in the rotor 20 according to the present embodiment, the hollow cylindrical core member 46, which covers the radially outer peripheries of the claw-shaped magnetic pole portions 44, is formed of the soft-magnetic sheets 56 that are laminated in the axial direction of the core member 46. Between each axially-adjacent pair of the soft-magnetic sheets 56, there is interposed one of the insulating layers 58 to electrically insulate the pair of the soft-magnetic sheets 56 from each other. The insulating layers 58 are spaced at the first intervals L1 in the axial direction of the core member 46. Moreover, each of the claw-shaped magnetic pole portions 44 has its radially outer peripheral surface abutting the core member 46 and the grooves 70 formed in the radially outer peripheral surface. Each of the grooves 70 is formed between one axially-adjacent pair of the abutting portions 72 of the claw-shaped magnetic pole portion 44 and constitutes an insulating layer that electrically insulates the pair of the abutting portions 72 from each other. The grooves 70 are spaced at the second intervals L2 in the axial direction of the core member 46.

With the above configuration, the insulating layers 58 of the core member 46 and the grooves 70 of the claw-shaped magnetic pole portions 44 each function as an electrically-insulating portion to reduce eddy current loss in a magnetic circuit along which magnetic flux flows between the stator 24 and the field core. As shown in FIG. 7, in the core member 46, there is generated eddy current that is divided for each of the soft-magnetic sheets 56 between the insulating layers 58; in each of the claw-shaped magnetic pole portions 44, there is generated eddy current that is divided for each of the abutting portions 72 between the grooves 70. In other words, eddy currents are generated separately in the soft-magnetic sheets 56 and the abutting portions 72 of the claw-shaped magnetic pole portions 44. These eddy currents interact with each other, distorting the shapes thereof. Consequently, the shapes of eddy current loops in the rotor 20 become complicated. In particular, since the first intervals L1 are unequal to the second intervals L2, the shapes of the eddy current loops become more complicated in comparison with the case where the first intervals L1 are equal to the second intervals L2.

Hence, with the above configuration of the rotor 20 according to the present embodiment, it becomes more difficult for eddy currents generated in the rotor 20 to flow and thus it becomes possible to further reduce the total eddy current loss in the rotor 20 in comparison with: the case where the core member 46 has the insulating layers 58 provided therein, but the claw-shaped magnetic pole portions 44 have no grooves 70 formed in their radially outer peripheral surfaces; and the case where the claw-shaped magnetic pole portions 44 have the grooves 70 formed in their radially outer peripheral surfaces, but the core member 46 has no insulating layers 58 provided therein.

Moreover, in the rotor 20 according to the present embodiment, since a further reduction in the total eddy current loss in the rotor 20 can be achieved as described above, it is unnecessary to increase the radial thickness of the core member 46 for the purpose of reducing the total eddy current loss in the rotor 20. Consequently, it becomes possible to effectively reduce the total eddy current loss in the rotor 20 with the radial thickness of the core member 46 kept small. That is, it becomes possible to effectively reduce the total eddy current loss in the rotor 20 while preventing occurrence of a magnetic short circuit in the core member 46.

It is only necessary for the depth of the grooves 70 to be set such that a further reduction in the total eddy current loss in the rotor 20 can be achieved in comparison with the case where the core member 46 has the insulating layers 58 provided therein, but the claw-shaped magnetic pole portions 44 have no grooves 70 formed in their radially outer peripheral surfaces. For example, the depth of the grooves 70 may be set so small as to be in the same level as the depth of a cutting trace. In this case, it is possible to form the grooves 70 during the process of machining the surfaces of the claw-shaped magnetic pole portions 44; thus, it is unnecessary to perform an additional special process for forming the grooves 70. Hence, it is possible to simply and easily form the grooves 70 in the radially outer peripheral surfaces of the claw-shaped magnetic pole portions 44, thereby achieving a further reduction in the total eddy current loss in the rotor 20.

Moreover, setting the depth of the grooves 70 to be small as described above, it is possible to suppress increase in the magnetic resistance of the claw-shaped magnetic pole portions 44 due to the grooves 70; thus it is also possible to suppress decrease in the magnetic force due to increase in the magnetic resistance of the claw-shaped magnetic pole portions 44. Consequently, it is possible to effectively reduce the total eddy current loss in the rotor 20 while suppressing increase in the magnetic resistance and thus decrease in the magnetic fore in the claw-shaped magnetic pole portions 44.

The above-described rotor 20 according to the present embodiment has the following advantages.

In the present embodiment, the rotor 20 includes the field core having the claw-shaped magnetic pole portions 44, the field coil 48 wound on the field core, and the hollow cylindrical core member 46 disposed to cover the radially outer peripheries of the claw-shaped magnetic pole portions 44 of the field core. The core member 46 has the insulating layers 58 (or first electrically-insulating portions) that are spaced at the first intervals L1 in the axial direction of the core member 46. Each of the claw-shaped magnetic pole portions 44 of the field core has its radially outer peripheral surface abutting the core member 46 and the grooves 70 (or second electrically-insulating portions) formed in the radially outer peripheral surface. The grooves 70 are spaced at the second intervals L2 in the axial direction of the core member 46.

With the above configuration, eddy current generated in the core member 46 is fragmented (or divided) by the insulating layers 58 of the core member 46; thus the eddy current loss in the core member 46 can be reduced. Moreover, for each of the claw-shaped magnetic pole portions 44, eddy current generated in the claw-shaped magnetic pole portion 44 is fragmented by the grooves 70 formed in the radially outer peripheral surface of the claw-shaped magnetic pole portion 44; thus the eddy current loss in the claw-shaped magnetic pole portion 44 can be reduced. Hence, it is unnecessary to increase the radial thickness of the core member 46 for the purpose of reducing the total eddy current loss in the rotor 20. Consequently, it becomes possible to effectively reduce the total eddy current loss in the rotor 20 with the radial thickness of the core member 46 kept small.

Moreover, in the present embodiment, the first intervals L1 are unequal to the second intervals L2.

Consequently, the shapes of eddy current loops in the rotor 20 become more complicated in comparison with the case where the first intervals L1 are equal to the second intervals L2. As a result, it becomes possible to further reduce the total eddy current loss in the rotor 20.

In the present embodiment, the core member 46 is formed of the soft-magnetic sheets 56 that are laminated in the axial direction of the core member 46. Each of the insulating layers 58 is interposed between one axially-adjacent pair of the soft-magnetic sheets 56 to electrically insulate the pair of the soft-magnetic sheets 56 from each other.

With the above configuration, it is possible to reliably reduce the eddy current loss in the core member 46.

In the present embodiment, each of the claw-shaped magnetic pole portions 44 of the field core has, as electrically-insulating portions, the grooves 70 formed in the radially outer peripheral surface thereof. In other words, the electrically-insulating portions provided on the radially outer peripheral surfaces of the claw-shaped magnetic pole portions 44 are constituted of the grooves 70.

With the above configuration, it is possible to reliably reduce the eddy current loss in the claw-shaped magnetic pole portions 44.

While the above particular embodiment has been shown and described, it will be understood by those skilled in the art that various modifications, changes, and improvements may be made without departing from the spirit of the present invention.

For example, in the above-described embodiment, the core member 46 is formed by laminating the soft-magnetic sheets (e.g., magnetic steel sheets) 56 in the axial direction.

However, the core member 46 may also be formed by, for example, spirally winding a soft-magnetic wire or strip on the radially outer peripheries of the claw-shaped magnetic pole portions 44 of the field core so as to have a plurality of portions of the soft-magnetic wire or strip laminated in the axial direction of the core member 46. In this case, it is possible to reduce waste of the soft-magnetic material in forming the core member 46. Moreover, it is also possible to keep the tension of the soft-magnetic wire or strip constant during the process of spirally winding it on the radially outer peripheries of the claw-shaped magnetic pole portions 44 of the field core. Consequently, it is possible to ensure both high quality and high productivity of the rotor 20. In addition, in terms of ensuring mechanical strength and magnetic performance, it is preferable for the soft-magnetic wire or strip to have a rectangular cross section. However, the soft-magnetic wire or strip may also have a circular cross section or a rectangular cross section with its corners rounded.

In the above-described embodiment, the hollow cylindrical core member 46 has a constant radial thickness and a radially outer peripheral surface where neither protrusion nor recess is formed. That is, all the points on the radially outer peripheral surface of the core member 46 are at the same distance from the axis of the core member 46 (or from the central axis O of the rotating shaft 50).

However, as shown in FIGS. 8 and 9, those portions of the core member 46 which face the gaps 54 formed between circumferentially-adjacent claw-shaped magnetic pole portions 44 of the field core may be recessed radially inward, thereby forming a plurality of grooves 100 in the radially outer peripheral surface of the core member 46. In this case, each of the grooves 100 extends along one of the gaps 54 formed between circumferentially-adjacent claw-shaped magnetic pole portions 44. Moreover, each of the grooves 100 is located at the same circumferential position as the boundary between one circumferentially-adjacent pair of the claw-shaped magnetic pole portions 44, i.e., located on the q axis extending between the circumferentially-adjacent pair of the claw-shaped magnetic pole portions 44. Each of the grooves 100 is circumferentially bisected by the q axis and has substantially the same circumferential width as the gap 54 along which the groove 100 is formed. The air gap formed between the stator 24 and the core member 46 is greater at the grooves 100 than at the other portions of the core member 46. Hence, the magnetic path between the rotor 20 and the stator 24 along the q axis is longer than that along the d axis. Consequently, it is possible to suppress magnetic flux fluctuation in the core member 46; it is also possible to suppress magnetic flux leakage from the rotor 20 to the stator 24 along the q-axis. As a result, it is possible to further reduce the total eddy current loss in the rotor 20.

In the rotor 20 according to the above-described embodiment, the core member 46 may have a lower magnetic permeability than the field core. In this case, it is more difficult for magnetic flux fluctuation to occur in the core member 46 than in the claw-shaped magnetic pole portions 44. Consequently, it is possible to suppress magnetic flux fluctuation in the core member 46, thereby further reducing the total eddy current loss in the rotor 20.

Moreover, the core member 46 may further have a higher saturation flux density than the field core. In this case, it is possible to suppress decrease in the maximum output of the rotating electric machine 22 while suppressing magnetic flux fluctuation in the core member 46. Consequently, it is possible to further reduce the total eddy current loss in the rotor 20 while maintaining the maximum output of the rotating electric machine 22.

In addition, the core member 46 may be made of a soft-magnetic material having a high saturation flux density, such as permendur which is a cobalt-iron alloy. On the other hand, the field core may be made of a soft-magnetic material having a higher magnetic permeability and a lower saturation flux density than the material of the core member 46, such as permalloy which is a nickel-iron alloy, pure iron (e.g., SUY according to JIS) or cold-rolled steel (e.g., SPCC or SPCE according to JIS).

In the above-described embodiment, the present invention is directed to the rotor 20 of the rotating electric machine 22 which is configured as a motor-generator for use in a motor vehicle. However, the present invention can also be applied to rotors for other rotating electric machines, such as a rotor for an electric motor or a rotor for an electric generator.

What is claimed is:

1. A rotor for a rotating electric machine, the rotor comprising:
a field core having a plurality of claw-shaped magnetic pole portions;
a field coil wound on the field core; and
a hollow cylindrical core member disposed to cover radially outer peripheries of the claw-shaped magnetic pole portions of the field core,
wherein
the core member has a plurality of first electrically-insulating portions that are spaced at first intervals in an axial direction of the core member, and
each of the claw-shaped magnetic pole portions of the field core has a radially outer peripheral surface abutting the core member and a plurality of second electrically-insulating portions provided on the radially outer peripheral surface, the second electrically-insulating portions being spaced at second intervals in the axial direction of the core member.

2. The rotor as set forth in claim 1, wherein the first intervals are unequal to the second intervals.

3. The rotor as set forth in claim 1, wherein the core member is formed of a plurality of soft-magnetic bodies that are laminated in the axial direction of the core member, and
the first electrically-insulating portions comprise a plurality of insulating layers each of which is interposed between one axially-adjacent pair of the soft-magnetic bodies to electrically insulate the pair of the soft-magnetic bodies from each other.

4. The rotor as set forth in claim 1, wherein the second electrically-insulating portions comprise a plurality of grooves formed in the radially outer peripheral surface of the claw-shaped magnetic pole portion.

5. The rotor as set forth in claim 1, wherein the claw-shaped magnetic pole portions of the field core are spaced in a circumferential direction of the core member with gaps formed therebetween,
the field coil is wound on the field core so that upon energization of the field coil, the claw-shaped magnetic pole portions are magnetized to respectively form a plurality of magnetic poles whose polarities alternate between north and south in the circumferential direction,
the rotor is rotatably disposed radially inside a stator in a rotating electric machine, and
the core member is formed so that an air gap between the core member and the stator is greater at portions of the core member which respectively face the gaps between the claw-shaped magnetic pole portions than at portions of the core member which respectively abut the claw-shaped magnetic pole portions.

6. The rotor as set forth in claim 1, wherein the core member has a lower magnetic permeability than the field core.

7. The rotor as set forth in claim 6, wherein the core member has a higher saturation flux density than the field core.

8. The rotor as set forth in claim 1, wherein the field core consists of a pair of first and second pole cores,
each of the first and second pole cores has a boss portion, a disc portion and a plurality of claw-shaped magnetic pole portions, the boss portion being cylindrical in shape, the disc portion extending radially outward from an axially outer part of the boss portion, each of the claw-shaped magnetic pole portions protruding axially inward from a radially outer part of the disc portion,
the claw-shaped magnetic pole portions of the first and second pole cores constitute the claw-shaped magnetic pole portions of the field core,
the claw-shaped magnetic pole portions of the first pole core are interleaved with the claw-shaped magnetic pole portions of the second pole core, and
the field coil is wound on radially outer peripheries of the boss portions of the first and second pole cores so that upon energization of the field coil, the claw-shaped magnetic pole portions of the first and second pole cores are magnetized to respectively form a plurality of magnetic poles whose polarities alternate between north and south in a circumferential direction of the core member.
